(19) United States
(12) Patent Application Publication
(10) Pub. No.: US 2025/0182171 A1
(43) Pub. Date: Jun. 5, 2025

(54) MEDIATION AND RATING SYSTEM

(71) Applicant: AppDirect, Inc., San Francisco, CA (US)

(72) Inventors: Amey Surendra Kamshetti, San Francisco, CA (US); Ajay Varma, San Francisco, CA (US); Saurav Varma, San Francisco, CA (US)

(21) Appl. No.: 18/968,776

(22) Filed: Dec. 4, 2024

Related U.S. Application Data
(60) Provisional application No. 63/605,791, filed on Dec. 4, 2023.

(51) Int. Cl. G06Q 30/04; G06Q 20/14

(52) U.S. Cl. CPC G06Q 30/04; G06Q 20/145

(57) ABSTRACT

As disclosed herein, a method for billing for usage of software applications is provided. The method may include receiving usage data associated with a software application and stored in a first plurality of user fields. The method may include aggregating the usage data using a unique identifier. The aggregated usage data may include values stored in a second plurality of user fields. The method may include receiving a mapping between the second plurality of user fields and a plurality of predefined fields. The method may include applying the mapping to the aggregated usage data to store the aggregated usage data in a usage database. The method may include applying a usage rate to the stored usage data to determine a total usage charge. The method may include generating a usage invoice based on the total usage charge. A system and a non-transitory computer-readable storage medium are also disclosed.

### CROSS-RELATED APPLICATIONS

The present application claims the benefit of priority under 35 U.S.C. § 119 (e) from U.S. Provisional Patent Application Ser. No. 63/605,791 entitled “SELF-SERVE MEDIATION AND RATING,” filed on Dec. 4, 2023, the disclosure of which is hereby incorporated by reference in its entirety for all purposes.

### BACKGROUND

### Technical Field

The present disclosure generally relates to software billing and, more particularly, to usage processing for software billing.

### Related Art

With the use of a mediation and rating system, data may be sent from a first system to a second system for processing. The first system may be associated with an independent software vendor (ISV) or a channel partner of an ISV (e.g., reseller, wholesaler, managed service provider (MSP)); and the second system may be a billing system associated with a software marketplace. Processing may include rating the data, paying for the data, or passing the data on after some modification to the data. Typically, an ISV or channel partner must agree on standard criteria for the billing system to assess and charge for consumption of software (or features, services, or the like, associated with the software) offered by the ISV or channel partner. The billing system specifies the standard criteria, or the ISV or channel partner works with the billing system to configure data processing. The ISV or channel partner sends usage data (e.g., recurring or metered usage data) to the billing system in a specified format via, for example, an application programming interface (API) or a standard file format. The usage data must be sent according to the standard criteria from all ISVs or channel partners. This increases the operational costs for the ISVs or channel partners. Additionally, because the specified format is predetermined by the billing system, it may be impossible to combine usage across primary keys.

### SUMMARY

The subject disclosure provides for methods and systems for billing for usage of software applications. A software marketplace may enable a user (e.g., an independent software vendor (ISV) or a channel partner of an ISV) to use a billing system of the marketplace to manage recurring (e.g., subscription-based) or metered (e.g., usage-based) billing for consumption of software products of the user. According to the present disclosure, during a configuration process, a user may upload raw usage data and define how the raw usage data fields should be mapped to standard usage data fields provided by the billing system. During an implementation process, the billing system may aggregate raw usage data, transform the aggregated usage data according to user definitions, map the transformed usage data to the standard format of the billing system, and generate an invoice according to the mapped usage data.

According to certain aspects of the present disclosure, a method for billing for usage of software applications is provided. The method may include receiving, from a user, a usage file. The usage file may store usage data associated with usage of a software application. The usage data may include a first number of raw events. Each raw event may include a first plurality of values stored in a first plurality of user fields. The method may include receiving, from the user, a definition of a unique identifier including one or more of the user fields. The method may include aggregating the usage data by combining matching raw events using the unique identifier, resulting in aggregated usage data. The aggregated usage data may include a second number of aggregated events. Each aggregated event may include a second plurality of values stored in a second plurality of user fields. The second number may be less than the first number, and the second plurality of user fields may be a first subset of the first plurality of user fields. The method may include receiving, from the user, a mapping between the second plurality of user fields and a plurality of predefined fields. The method may include applying the mapping to the aggregated usage data to store the aggregated usage data in a usage database, resulting in stored usage data. The stored usage data may include a third number of usage events. Each usage event may include a third plurality of values stored in the plurality of predefined fields. The method may include applying a usage rate to the stored usage data to determine a total usage charge. The method may include generating a usage invoice based on the total usage charge.

According to another aspect of the present disclosure, a non-transitory computer-readable medium storing a program for billing for usage of software applications is provided. The program, when executed by a computer, may configure the computer to receive, from a user, a usage file. The usage file may store usage data associated with usage of a software application. The usage data may include a first number of raw events. Each raw event may include a first plurality of values stored in a first plurality of user fields. The program, when executed by the computer, may configure the computer to receive, from the user, a definition of a unique identifier comprising one or more of the user fields. The program, when executed by the computer, may configure the computer to aggregate the usage data by combining matching raw events using the unique identifier, resulting in aggregated usage data. The aggregated usage data may include a second number of aggregated events. Each aggregated event may include a second plurality of values stored in a second plurality of user fields. The second number may be less than the first number, and the second plurality of user fields may be a first subset of the first plurality of user fields. The program, when executed by the computer, may configure the computer to receive, from the user, a mapping between the second plurality of user fields and a plurality of predefined fields. The program, when executed by the computer, may configure the computer to apply the mapping to the aggregated usage data to store the aggregated usage data in a usage database, resulting in stored usage data. The stored usage data may include a third number of usage events. Each usage event may include a third plurality of values stored in the plurality of predefined fields. The program, when executed by the computer, may configure the computer to apply a usage rate to the stored usage data to determine a total usage charge. The program, when executed by the computer, may configure the computer to generate a usage invoice based on the total usage charge.

According to yet other aspects of the present disclosure, a system for billing for usage of software applications is provided. The system may include a processor. The system may include a non-transitory computer-readable medium storing a set of instructions, which when executed by the processor, may configure the system to receive, from a user, a usage file. The usage file may store usage data associated with usage of a software application. The usage data may include a first number of raw events. Each raw event may include a first plurality of values stored in a first plurality of user fields. The instructions, when executed by the processor, may configure the system to receive, from the user, a definition of a unique identifier comprising one or more of the user fields. The instructions, when executed by the processor, may configure the system to aggregate the usage data by combining matching raw events using the unique identifier, resulting in aggregated usage data. The aggregated usage data may include a second number of aggregated events. Each aggregated event may include a second plurality of values stored in a second plurality of user fields. The second number may be less than the first number, and the second plurality of user fields may be a subset of the first plurality of user fields. The instructions, when executed by the processor, may configure the system to receive, from the user, a mapping between the second plurality of user fields and a plurality of predefined fields. The instructions, when executed by the processor, may configure the system to apply the mapping to the aggregated usage data to store the aggregated usage data in a usage database, resulting in stored usage data. The stored usage data may include a third number of usage events. Each usage event may include a third plurality of values stored in the plurality of predefined fields. The instructions, when executed by the processor, may configure the system to apply a usage rate to the stored usage data to determine a total usage charge. The instructions, when executed by the processor, may configure the system to generate a usage invoice based on the total usage charge. The unique identifier may include one or more of a subscription identifier, a customer account identifier, a software application identifier, or a software version identifier.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example environment suitable for billing for usage of software applications, according to some embodiments;

FIG. 2 is a block diagram illustrating details of an example client device and an example server from the example environment of FIG. 1, according to some embodiments;

FIG. 3 illustrates an example usage processing interface used in a billing system of the example environment of FIG. 1, according to some embodiments;

FIG. 4 illustrates example usage processing definition for a billing system of the example environment of FIG. 1, according to some embodiments;

FIGS. 5A-5B illustrate example usage processing definition and example usage processing implementation, according to some embodiments;

FIG. 6 illustrates an example user interface for field selection during usage processing definition for a billing system, according to some embodiments;

FIG. 7 illustrates an example user interface for field mapping during usage processing definition for a billing system, according to some embodiments;

FIG. 8 illustrates an example user interface for enrichment during usage processing definition for a billing system, according to some embodiments;

FIG. 9 illustrates an example user interface for rating during usage processing definition for a billing system, according to some embodiments;

FIGS. 10A-10B illustrate an example user interface for review of the configuration during usage processing definition for a billing system, according to some embodiments;

FIG. 11 is a flowchart illustrating operations in a method for billing for usage of software applications, according to some embodiments; and

FIG. 12 is a block diagram illustrating an exemplary computer system with which client devices, and the methods or processes described in FIGS. 3-5 and 11, may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

With the use of a mediation and rating system, data may be sent from a first system to a second system for processing. The first system may be associated with an independent software vendor (ISV) or a channel partner of an ISV (e.g., reseller, wholesaler, managed service provider (MSP)); and the second system may be a billing system associated with a software marketplace. Processing may include rating the data, paying for the data, or passing the data on after some modification to the data. Typically, an ISV or channel partner must agree on standard criteria for the billing system to assess and charge for consumption of software (or features, services, or the like, associated with the software) offered by the ISV or channel partner. The billing system specifies the standard criteria, or the ISV or channel partner works with the billing system to configure data processing. The ISV or channel partner sends usage data (e.g., recurring or metered usage data) to the billing system in a specified format via, for example, an application programming interface (API) or a standard file format. The usage data must be sent according to the standard criteria from all ISVs or channel partners. This increases the operational costs for the ISVs or channel partners. Additionally, because the specified format is predetermined by the billing system, it may be impossible to combine usage across primary keys.

ISVs or channel partners may use a revenue strategy and pricing model to incentivize consumption. Typically, billing systems allow ISVs or channel partners to send and process usage events in a certain or predefined format. However, some ISVs or channel partners may wish to process usage in certain ways that may deviate from the standard format or the way the ISV or channel partner sends usage events (e.g., pre-rated usage events).

As disclosed herein, novel systems and methods represent a significant advancement in the field of software billing by enabling a user of a billing system (e.g., an independent software vendor (ISV), a channel partner of an ISV) to customize usage definitions using files and data formats of the user. Customizing usage definitions may include, but is not limited to, choosing which usage fields (e.g., account identification (ID), event ID, quantity, unit price) are required and which are unique identifications; transforming or enriching the fields (e.g., using scripting, logic, or conditionals); providing a rating rationale (e.g., which exchange rate to choose, whether events should be prorated, whether events should be rated specifically, etc.); and giving specific markup (e.g., if an attribute has a certain value, rate it differently). Once a usage definition and configuration has been completed, some embodiments of the present disclosure may enable aggregation, parsing, enrichment, or rating logic for usage processing, enabling a user to send usage data to the billing system in a customized format of the user. In some embodiments, a user may provide usage definitions to the billing system via an application programming interface (API), a user interface, or both.

### TERMINOLOGY

Application: As used herein, an “application” may refer to a software product. Examples of applications include software-as-a-service (SaaS) offerings, platform-as-a-service (PaaS) offerings, and infrastructure-as-a-service (IaaS) offerings, as well as traditional downloadable software. In colloquial terms, “buying software” may refer to the more specific legal act of obtaining a license. References to the colloquial “buying” or “selling” with respect to software should be understood as shorthand for “purchasing, or selling, a license” or just “licensing.” The license itself can have many characteristics, including a time duration (e.g., perpetual or time limited). Time-limited licenses are sometimes referred to as “subscriptions.”

Subscription: As used herein, “subscription” may refer to an electronic representation of any license. “Entitlements” or “user entitlements” may similarly refer to electronic representations of an assignment of access permissions under a license to a given end user (i.e., a customer). Subscriptions may have many boundary dimensions (e.g., number of users, length of access, amount of data used per time period, messages sent per time period). Thus, if “My Traditional Software Application” is a downloadable application, then the subscription would correspond to the license terms (e.g., one year access for one user), and the entitlement would reflect which end user was assigned the access. Similarly, if “My SaaS Application” is an SaaS application, then the subscription would correspond to the license (e.g., ten end users on standard edition at $45/user/month), and the entitlements would reflect the assignment of up to ten specific end users (e.g., within the same company) to those ten licenses. Subscription models may include, but are not limited to, per-view, per-seat, per-user, per-data unit (e.g., per megabyte, per gigabyte, etc.) or any other usage metric.

Independent software vendors (ISVs): As used herein, “independent software vendor (ISV)” may refer to an individual, company, or organization that develops and provides software products.

Channel partner: As used herein, “channel partner” may refer to an individual, company, or organization that collaborates with a software developer or vendor (e.g., an ISV) to market, sell, distribute, or support the products or services of the developer or vendor. By way of non-limiting examples, a channel partner may include a wholesaler, reseller, managed service provider (MSP), or the like.

Marketplace (or software marketplace): As used herein, a “marketplace” (or “software marketplace”) may be a platform or website, or in some cases an application, through which other applications may be purchased. This indirect delivery mechanism may allow ISVs or channel partners to benefit from the reach of the marketplace, such as the sales force, customer base, customer loyalty, or the like, of the marketplace. An ISV or a channel partner may be a user of a marketplace. A customer may be an individual or organization who purchases a software product of the ISV or the channel partner. The customer may purchase the software product indirectly (i.e., via the marketplace), or the customer may purchase the software product directly (i.e., from the ISV or channel partner, via a system of the ISV or channel partner).

Usage processing definition: As used herein, the phrase “usage processing definition” may refer to defining a format for processing, recording, or tracking usage of software (or usage of features, services, or the like, associated with the software).

### Example System Architecture

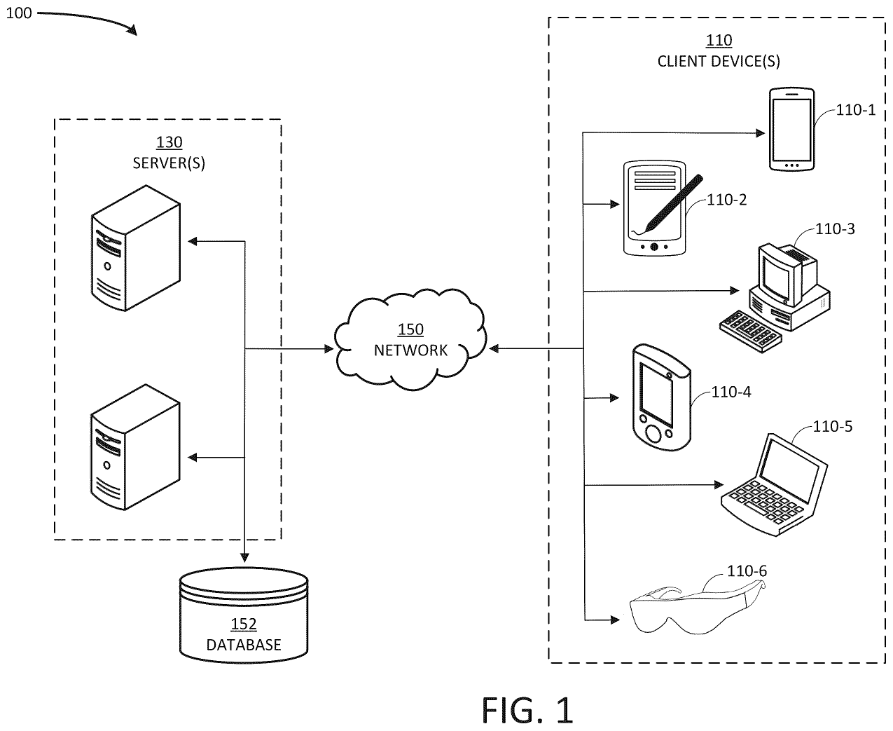

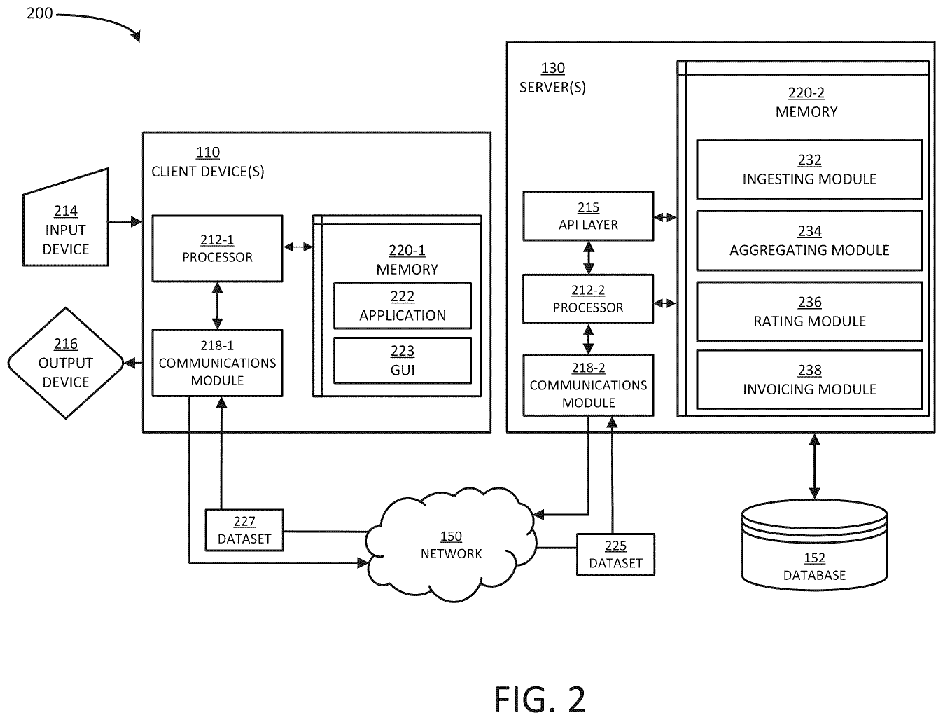

FIG. 1 illustrates an example environment 100 suitable for billing for usage of software applications, according to some embodiments. Environment 100 may include server(s) 130 communicatively coupled with client device(s) 110 and database 152 over network 150. One of server(s) 130 may be configured to host a memory including instructions which, when executed by a processor, cause server(s) 130 to perform at least some of the steps or operations in methods or processes as disclosed herein. In some embodiments, the processor may be configured to control a graphical user interface (GUI) for the user of one of client device(s) 110 accessing an ingesting module (e.g., ingesting module 232, FIG. 2), an aggregating module (e.g., aggregating module 234, FIG. 2), a rating module (e.g., rating module 236, FIG. 2), or an invoicing module (e.g., invoicing module 238, FIG. 2) with an application (e.g., application 222, FIG. 2). Accordingly, the processor may include a dashboard tool, configured to display components and graphic results to the user via a GUI (e.g., GUI 223, FIG. 2). For purposes of load balancing, multiple servers of server(s) 130 may host memories including instructions to one or more processors, and multiple servers of server(s) 130 may host a history log and a database 152 including multiple training archives for the ingesting module, the aggregating module, the rating module, or the invoicing module. Moreover, in some embodiments, multiple users of client device(s) 110 may access the same ingesting module, aggregating module, rating module, or invoicing module. In some embodiments, a single user with a single client device (e.g., one of client device(s) 110) may provide data (e.g., text) to train one or more machine learning models running in parallel in one or more server(s) 130. Accordingly, client device(s) 110 and server(s) 130 may communicate with each other via network 150 and resources located therein, such as data in database 152.

Server(s) 130 may include any device having an appropriate processor, memory, and communications capability for hosting the ingesting module, the aggregating module, the rating module, or the invoicing module. Any of the ingesting module, the aggregating module, the rating module, or the invoicing module may be accessible by client device(s) 110 over network 150.

Client device(s) 110 may include any one of a laptop computer 110-5, a desktop computer 110-3, or a mobile device, such as a smartphone 110-1, a palm device 110-4, or a tablet device 110-2. In some embodiments, client device(s) 110 may include a headset or other wearable device 110-6 (e.g., a virtual reality headset, augmented reality headset, or smart glass), such that at least one user may be running an application (e.g., application 222) installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate client device(s) 110 that may include a smartphone device 110-1 (e.g., an IPHONE® device, an ANDROID® device, a BLACKBERRY® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to network 150. Smartphone device 110-1 may execute a client, Web browser, or other local application to access server(s) 130.

A user may own or operate client device(s) 110 that may include a tablet device 110-2 (e.g., an IPAD® tablet device, an ANDROID® tablet device, a KINDLE FIRE® tablet device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to network 150. Tablet device 110-2 may execute a client, Web browser, or other local application to access server(s) 130.

The user may own or operate client device(s) 110 that may include laptop computer 110-5 (e.g., a MAC OS® device, WINDOWS® device, LINUX® device, or other computer device running another operating system). Laptop computer 110-5 may be an Ethernet device capable of connecting to a network 150 via an Ethernet connection. In some embodiments and in some cases, laptop computer 110-5 may additionally or alternatively use cellular, Wi-Fi, or other networking technologies to connect to network 150. Laptop computer 110-5 may execute a client, Web browser, or other local application to access server(s) 130.

FIG. 2 is a block diagram 200 illustrating details of example client device(s) 110 and example server(s) 130 that may be used in computerized systems and methods as disclosed herein, according to some embodiments. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client device(s) 110 may be coupled with input device 214 and with output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to client device(s) 110. Likewise, output device 216 may include a display and a speaker with which the customer may retrieve results from client device(s) 110. Client device(s) 110 may also include a processor 212-1, configured to execute instructions stored in a memory 220-1, and to cause client device(s) 110 to perform at least some of the steps in methods consistent with the present disclosure. Memory 220-1 may further include an application 222 and a graphical user interface (GUI) 223, configured to run in client device(s) 110 and couple with input device 214 and output device 216. Application 222 may be downloaded by the user from server(s) 130 and may be hosted by server(s) 130. In some embodiments, client device(s) 110 may be a laptop computer (e.g., laptop computer 110-5), and application 222 may be an application of a billing system (e.g., application 222). In some embodiments, client device(s) 110 may be a mobile phone used to collect data and upload to server(s) 130 using an application (e.g., application 222), to store in database 152. In some embodiments, application 222 may run on any operating system (OS) installed in client device(s) 110. In some embodiments, application 222 may run out of a Web browser, installed in client device(s) 110.

Dataset 227 may include multiple messages or multimedia files. A user of client device(s) 110 may store at least some of the messages and data content in dataset 227 in memory 220-1. In some embodiments, a participant may upload, with client device(s) 110, dataset 225 onto server(s) 130. Database 152 may store data and files associated with application 222 (e.g., one or more of datasets 225 and 227).

Server(s) 130 may include application programming interface (API) layer 215, which may control application 222 in each of client device(s) 110. Server(s) 130 may also include memory 220-2 storing instructions which, when executed by a processor 212-2, cause server(s) 130 to perform at least partially one or more operations in methods consistent with the present disclosure.

Processors 212-1 and 212-2, and memories 220-1 and 220-2 will be collectively referred to, hereinafter, as “processors 212” and “memories 220,” respectively.

Processors 212 may be configured to execute instructions stored in memories 220. In some embodiments, memory 220-2 may include ingesting module 232, aggregating module 234, rating module 236, or invoicing module 238. Ingesting module 232, aggregating module 234, rating module 236, or invoicing module 238 may share or provide features and resources to GUI 223. A user may access ingesting module 232, aggregating module 234, rating module 236, or invoicing module 238 through application 222, installed in memory 220-1 of client device(s) 110. Accordingly, application 222, including GUI 223, may be installed by server(s) 130 and perform scripts and other routines provided by server(s) 130 through any one of multiple tools. Execution of application 222 may be controlled by processor 212-1.

Ingesting module 232 may be designed to configure or manage the intake of various usage files from various external systems, ensuring data integrity, real-time processing, or proper validation before the usage files or the data included therein undergo further processing. For example, a usage file may be a JavaScript Object Notation (JSON) file, a comma-separated values (CSV) file, or a text file.

Ingesting module 232 may be designed to interact with a variety of external systems that provide raw usage data for billing or payment processes. For example, external systems may include systems of software developers, vendors, or channel partners, or associated application programming interfaces (APIs), that track recurring (e.g., subscription-based) or metered (e.g., usage-based) consumption of software or of features or services associated with the software. Raw usage data may include the following: product data, such as software type, name, model, version, description, or price; transactional data, such as information about payments, refunds, charges, or successful transactions; subscription data, such as subscription start, renewal, upgrade, downgrade, or cancellation statuses; metrics on when or how much of a software product, service, or feature is consumed (e.g., API calls, storage usage), including date or time records associated with consumption events (e.g., raw events); or customer data, such as customer ID, customer profile, customer account status, customer billing details, or customer purchase history.

Ingesting module 232 may be designed to accommodate various communication protocols and data formats depending on the source system. For example, ingesting module 232 may accommodate APIs, file uploads (e.g., CSV files, JSON files, Extensible Markup Language (XML) files), message queues, or data synchronization services.

Ingesting module 232 may receive, from a user (e.g., an ISV, a channel partner of an ISV), a usage file storing usage data. The usage data may be associated with usage of a software application provided by the user. The usage data may include a first number of raw events. Each raw event may include a first plurality of values stored in a first plurality of user fields. In some embodiments, the usage file may be one of a JavaScript Object Notation (JSON) file, a comma-separated values (CSV) file, or a text file. In some embodiments, ingesting module 232 may receive, from the user, a definition of at least one additional user field that is not represented in the usage file.

Ingesting module 232 may receive a definition of a unique identifier including one or more of the user fields. In some embodiments, at least one of the usage file and the definition of the unique identifier may be received from the user through an application programming interface (API). In some embodiments, at least one of the usage file and the definition of the unique identifier may be received from the user through a graphical user interface. In some embodiments, the unique identifier may include one or more of a recurring usage identifier (e.g., a subscription identifier), a metered usage identifier, a user account identifier, a customer account identifier, a software application identifier, or a software version identifier.

Ingesting module 232 may apply, to each raw event, one or more validation rules to ensure raw event data is clean, accurate, or ready to be processed. Ingesting module 232 may perform format validation by ensuring incoming raw event data is in an expected format (e.g., JSON, CSV, XML) and meets schema requirements (e.g., required fields, correct data types). Ingesting module 232 may perform field validation to ensure all necessary fields of the first plurality of user fields are present. Raw events including invalid or missing user fields, or raw events that otherwise fail to satisfy a validation rule, may trigger alerts for manual review or may be rejected or discarded. Ingesting module 232 may perform data consistency checks to validate that raw event data matches existing records where applicable (e.g., checking whether a customer ID exists before processing a subscription update). Ingesting module 232 may perform duplication checks to ensure that duplicate raw event data is not ingested.

Aggregating module 234 may be designed to configure or manage combining, organizing, or synthesizing raw usage data from various sources into a unified format.

Aggregating module 234 may aggregate usage data by combining matching raw events using the unique identifier, resulting in aggregated usage data. The aggregated usage data may include a second number of aggregated events. Each aggregated event may include a second plurality of values stored in a second plurality of user fields. The second number of aggregated events may be less than the first number of raw events, and the second plurality of user fields may be a first subset of the first plurality of user fields.

Aggregating module 234 may receive, from the user, a mapping between the second plurality of user fields and a plurality of predefined fields. In some embodiments, aggregating module 234 may receive, from the user, a definition of a data transformation operation. The data transformation operation may include receiving, as input, data from at least one field in the second plurality of user fields, and generating, as output, data to be stored in at least one field in the plurality of predefined fields. Aggregating module 234 may perform the data transformation operation on the aggregated usage data. In some embodiments, the data transformation operation may include one or more of a scripting operation, a logic operation, or a conditional operation.

Aggregating module 234 may apply the mapping to aggregated usage data to store the aggregated usage data in a usage database, resulting in stored usage data. The stored usage data may include a third number of usage events. Each usage event may include a third plurality of values stored in the plurality of predefined fields.

Aggregating module 234 may further transform or enrich usage data to make the usage data more suitable for further processing. For one example, aggregating module 234 may convert currency values into a common format or convert a payment method status code (e.g., “A” for active) into a human-readable string. For another example, aggregating module 234 may normalize usage data to a consistent unit of measurement (e.g., converting gigabytes to megabytes, or minutes to hours) predefined by the billing system. For a further example, aggregating module 234 may convert transaction amounts into the default currency of the billing system using up-to-date exchange rates. For yet another example, aggregating module 234 may enrich the usage data with additional context (e.g., customer information, such as account type, contract terms, or demographics) from internal systems or third-party sources.

Aggregating module 234 may initiate the aggregating of data based on time. For example, usage data may be aggregated based on specific time periods (e.g., daily, weekly, monthly), and the billing system may calculate charges accordingly. For another example, usage data may be aggregated according to a billing cycle of a user (e.g., monthly, quarterly, annually), ensuring that all activities and charges align with the correct billing period. For yet another example, usage data may be aggregated over rolling periods (e.g., the last fourteen (14) days) to assess usage and calculate dynamic charges in real time.

Aggregating module 234 may initiate the aggregating of data on a per-customer basis to allow the billing system to generate invoices, apply discounts, or perform account reconciliation. All transactions, payments, refunds, or credits may be aggregated for each customer account. This may enable the billing system to calculate total charges or outstanding balances, or to create a comprehensive financial history for each customer.

Rating module 236 may be designed to configure or manage how much a customer should be charged for software usage. Rating module 236 may receive, from the user, a definition of a usage rate card. The definition of the usage rate card may include a usage rate, rating rule, or rating logic for at least one field in the second plurality of user fields and a usage rate modifier. Rating module 236 may apply a usage rate, rating rule, or rating logic to the stored usage data to determine a total usage charge. An invoice may be generated based on the total usage charge. The total usage charge may be further determined by applying the usage rate modifier to an aggregated event that matches the usage rate, rating rule, or rating logic. In some embodiments, the rating rule may include an exchange rate or a prorated rate, which may be defined by a user or determined by the billing system. Rating module 236 may use the exchange rate or the prorated rate to evaluate at least one value of the at least one field in the second plurality of user fields.

Rating module 236 may apply, to usage data, rating logic to determine a total charge for a given period (e.g., monthly, quarterly). Rating module 236 may receive the rating logic from a user, or the rating logic may be predetermined by the billing system. Rating module 236 may be designed to apply rating logic for various pricing models. Example pricing models may include the following or a combination thereof: fixed pricing, wherein a flat rate is charged based on a subscription plan or a bundle of features; usage-based pricing, wherein charges depend on actual use of software or services, such as the number of API calls, data storage, or bandwidth usage; tiered or sliding scale pricing, wherein charges depend on usage thresholds or customer tiers (e.g., the first 100 units at $0.10/unit, the next 500 units at $0.08/unit); volume-based pricing, wherein discounts are applied based on the volume of usage or purchases (e.g., higher usage triggers a discount on per-unit rate); conditional pricing, wherein charges may be modified depending on certain conditions (e.g., a special discount might apply if a customer exceeds a particular usage threshold, or a service fee might apply if a customer uses a premium feature); or custom pricing, wherein charges include special pricing for individual customers (e.g., negotiated discounts, loyalty rewards, or custom bundles).

Rating module 236 may perform calculations to determine the total charge for usage. The calculations may factor in various elements such as unit costs (e.g., the rate for each unit consumed per API call, per GB of storage, per user); usage data, such as number of units consumed, duration of service usage, or volume of transaction; or dynamic pricing, wherein rates may be adjusted based on variable conditions, such as peak usage periods, promotional discounts, or customer-specific agreements.

Rating module 236 may receive from a user, or may automatically determine, the rating logic according to a rate plan or pricing model that is applicable to each customer of the user based on usage details, user account information, or customer account information. For example, determining the rating logic may include identifying whether a customer is on a monthly subscription, annual plan, or pay-as-you-go model. For another example, determining the rating logic may include selecting the correct rate for a free tier or a premium service based on the active plan of the customer.

Rating module 236 may apply adjustments (e.g., credits, refunds) or discounts to the total charges. For example, adjustments or discounts may include special rates for a customer who pays a bill early; volume discounts for a customer who reaches a specific usage threshold; loyalty discounts for a customer who has been a customer for at least a certain period of time; or promotional discounts for new or returning customers.

Invoicing module 238 may be designed to generate, update, or transmit invoices to users or customers of users based on charges (e.g., total charges) determined by the billing system. Invoicing module 238 may support various pricing models, payment terms, or invoicing features of various users. An invoice may include a breakdown of product usage, charges, discounts, taxes, or adjustments. For example, for each billing cycle (e.g., monthly, quarterly, annual), invoicing module 238 may create an invoice for a customer with a unique invoice number and timestamp. The invoice may correspond to the account, subscription plan, or usage history of the customer.

An invoice may include line items such as subscription tier; license information (e.g., number, list, or status of licenses); descriptions of products, services, or features; subscription charges (e.g., fixed or recurring charges); usage charges (e.g., API calls, storage usage, bandwidth charges); add-on, overage, maintenance, or support charges; discounts, promotions, or loyalty rewards; taxes or regulatory fees; credits, refunds, or adjustments.

Invoicing module 238 may generate an invoice in a preferred currency of a user, in a preferred currency of a customer of the user, or in the currency used in a transaction conducted between the user and the customer (e.g., via the marketplace, via a system of the user). If the user operates in multiple currencies, then exchange rates may be applied during invoice generation. Invoicing module 238 may receive, from a user, a definition of an invoice template, enabling a user to customize the invoice to include, for example, a specific logo, color scheme, or font.

Once the invoice is generated, invoicing module 238 may initiate delivery of the invoice to the user or to the customer. For one example, a method of invoice delivery may include email. In such examples, invoicing module 238 may send an invoice automatically via email to an email address of a user or a customer. The email may include a Portable Document Format (PDF) or Hypertext Markup Language (HTML) version of the invoice as an attachment or an embedded link. If the invoice is overdue or approaching the payment due date, invoicing module 238 may send automated reminders or follow-up emails to the user or the customer. For another example, a method of invoice delivery may include a portal or dashboard of the billing system or the marketplace. In such examples, invoicing module 238 may make an invoice available for viewing or downloading, by a user or a customer, via the portal or dashboard. Using the portal or dashboard, a user or customer may access or view invoice history, download past invoices, track payments, or view a status of an invoice, which invoicing module 238 may update in real time. For yet another example, a method of invoice delivery may include physical invoicing. In such examples, invoicing module 238 may initiate the printing of a physical invoice, which may be mailed to a physical address of a customer. Invoicing module 238 may integrate with third-party services to automate printing and mailing of invoices.

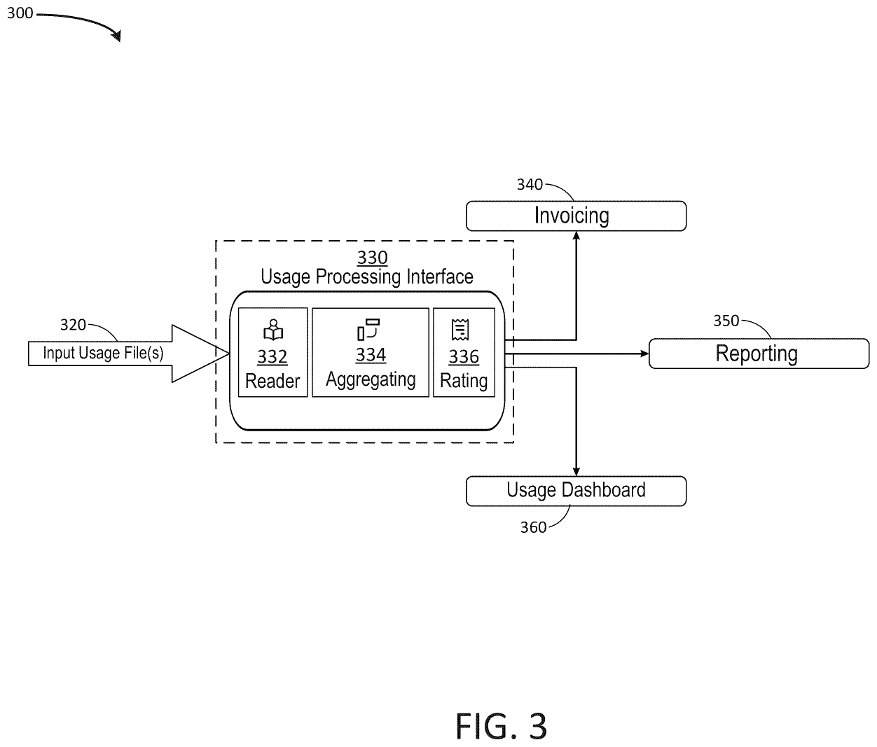

FIG. 3 illustrates example usage processing interface 330 used in billing system 300 of example environment 100 of FIG. 1, according to some embodiments. Environment 100 may include a software marketplace. Billing system 300 may include usage processing interface 330, which may include ingesting module 332, aggregating module 334, and rating module 336.

Ingesting module 332 may be designed to configure or manage the intake of input usage file(s) 320 from various external systems, ensuring data integrity, real-time processing, or proper validation before input usage file(s) 320 or the data included therein undergo further processing. For example, input usage file(s) 320 may be JavaScript Object Notation (JSON) files, comma-separated values (CSV) files, or text files.

Ingesting module 332 may receive, from a user (e.g., an ISV, a channel partner of an ISV), input usage file(s) 320 storing usage data. The usage data may be associated with usage of a software application provided by the user. In some embodiments, the application may be provided via a system of the user. In some embodiments, the application may be provided via a software marketplace including the billing system. The usage data may include a first number of raw events. Each raw event may include a first plurality of values stored in a first plurality of user fields. In some embodiments, input usage file(s) 320 may be one of a JavaScript Object Notation (JSON) file, a comma-separated values (CSV) file, or a text file. In some embodiments, ingesting module 332 may receive, from the user, a definition of at least one additional user field that is not represented in the usage file.

Ingesting module 332 may receive a definition of a unique identifier including one or more of the user fields. In some embodiments, at least one of input usage file(s) 320 and the definition of the unique identifier may be received from the user through an application programming interface (API). In some embodiments, at least one of input usage file(s) 320 and the definition of the unique identifier may be received from the user through a graphical user interface. In some embodiments, the unique identifier may include one or more of a recurring usage identifier (e.g., a subscription identifier), a metered usage identifier, a user account identifier, a customer account identifier, a software application identifier, or a software version identifier.

Ingesting module 332 may apply, to each raw event, one or more validation rules to ensure raw event data is clean, accurate, or ready to be processed. Ingesting module 332 may perform format validation by ensuring incoming raw event data is in an expected format (e.g., JSON, CSV, XML) and meets schema requirements (e.g., required fields, correct data types). Ingesting module 332 may perform field validation to ensure all necessary fields of the first plurality of user fields are present. Raw events including invalid or missing user fields, or raw events that otherwise fail to satisfy a validation rule, may trigger alerts for manual review or may be rejected or discarded. Ingesting module 332 may perform data consistency checks to validate that raw event data matches existing records where applicable (e.g., checking whether a customer ID exists before processing a subscription update). Ingesting module 332 may perform duplication checks to ensure that duplicate raw event data is not ingested.

Aggregating module 334 may be designed to configure or manage combining, organizing, or synthesizing raw usage data from various sources into a unified format. Aggregating module 334 may aggregate usage data by combining matching raw events using the unique identifier, resulting in aggregated usage data. The aggregated usage data may include a second number of aggregated events. Each aggregated event may include a second plurality of values stored in a second plurality of user fields. The second number of aggregated events may be less than the first number of raw events, and the second plurality of user fields may be a first subset of the first plurality of user fields.

Aggregating module 334 may receive, from the user, a mapping between the second plurality of user fields and a plurality of predefined fields. In some embodiments, aggregating module 334 may receive, from the user, a definition of a data transformation operation. The data transformation operation may include receiving, as input, data from at least one field in the second plurality of user fields, and generating, as output, data to be stored in at least one field in the plurality of predefined fields. Aggregating module 334 may perform the data transformation operation on the aggregated usage data. In some embodiments, the data transformation operation may include one or more of a scripting operation, a logic operation, or a conditional operation.

Aggregating module 334 may apply the mapping to aggregated usage data to store the aggregated usage data in a usage database, resulting in stored usage data. The stored usage data may include a third number of usage events. Each usage event may include a third plurality of values stored in the plurality of predefined fields.

Rating module 336 may be designed to configure or manage how much a customer should be charged for software usage. Rating module 336 may receive, from the user, a definition of a usage rate card. The definition of the usage rate card may include a usage rate, rating rule, or rating logic for at least one field in the second plurality of user fields and a usage rate modifier. Rating module 336 may apply a usage rate, rating rule, or rating logic to the stored usage data to determine a total usage charge. An invoice may be generated (e.g., by invoicing module 340) based on the total usage charge. The total usage charge may be further determined by applying the usage rate modifier to an aggregated event that matches the usage rate, rating rule, or rating logic. In some embodiments, the rating rule may include an exchange rate or a prorated rate, which may be defined by a user or determined by billing system 300. Rating module 336 may use the exchange rate or the prorated rate to evaluate at least one value of the at least one field in the second plurality of user fields.

Rating module 336 may apply, to usage data, rating logic to determine a total charge for a given period (e.g., monthly, quarterly). Rating module 336 may receive the rating logic from a user, or the rating logic may be predetermined by billing system 300. Rating module 336 may be designed to apply rating logic for various pricing models. Example pricing models may include the following or a combination thereof: fixed pricing, wherein a flat rate is charged based on a subscription plan or a bundle of features; usage-based pricing, wherein charges depend on actual use of software or services, such as the number of API calls, data storage, or bandwidth usage; tiered or sliding scale pricing, wherein charges depend on usage thresholds or customer tiers (e.g., the first 100 units at $0.10/unit, the next 500 units at $0.08/unit); volume-based pricing, wherein discounts are applied based on the volume of usage or purchases (e.g., higher usage triggers a discount on per-unit rate); conditional pricing, wherein charges may be modified depending on certain conditions (e.g., a special discount might apply if a customer exceeds a particular usage threshold, or a service fee might apply if a customer uses a premium feature); or custom pricing, wherein charges include special pricing for individual customers (e.g., negotiated discounts, loyalty rewards, or custom bundles).

Rating module 336 may perform calculations to determine the total charge for usage. The calculations may factor in various elements such as unit costs (e.g., the rate for each unit consumed per API call, per GB of storage, per user); usage data, such as number of units consumed, duration of service usage, or volume of transaction; or dynamic pricing, wherein rates may be adjusted based on variable conditions, such as peak usage periods, promotional discounts, or customer-specific agreements.

Rating module 336 may receive from a user, or may automatically determine, the rating logic according to a rate plan or pricing model that is applicable to each customer of the user based on usage details, user account information, or customer account information. For example, determining the rating logic may include identifying whether a customer is on a monthly subscription, annual plan, or pay-as-you-go model. For another example, determining the rating logic may include selecting the correct rate for a free tier or a premium service based on the active plan of the customer.

Once the rating logic has been applied to the usage data, the processed usage data may be transmitted to other modules of billing system 300, such as invoicing module 340, reporting module 350, or usage dashboard 360.

Invoicing module 340 may be designed to generate, update, or transmit invoices to users or customers of users based on charges (e.g., total charges) determined according to the processed usage data. Invoicing module 340 may support various pricing models, payment terms, or invoicing features of various users. An invoice may include a breakdown of product usage, charges, discounts, taxes, or adjustments. For example, for each billing cycle (e.g., monthly, quarterly, annual), invoicing module 340 may create an invoice for a user or a customer with a unique invoice number and timestamp. The invoice may correspond to the account, subscription plan, or usage history of a customer.

Reporting module 350 may be configured to generate rating reports that use processed usage data to summarize the charges applied to each customer on a recurring (e.g., subscription-based) basis, a metered (e.g., usage-based) basis, or a combination thereof. The rating report may include a breakdown of charges, including a detailed view of the services consumed, the associated rates, or the calculated costs. The rating report may include usage details, including an itemized list of the usage of a customer (e.g., API calls, gigabytes of storage). The rating report may include discount or tax details, including information on applied discounts and tax calculations, including tax rates by region. In some embodiments, reporting module 350 may generate usage reports that summarize processed usage data or unprocessed usage data. Processed usage data may include usage data to which rating logic has been applied. Unprocessed usage data may include usage data to which rating logic has not been applied (e.g., discarded raw event data).

Usage dashboard 360 may be configured to use processed usage data to provide to a user (e.g., an ISV, a channel partner of an ISV) real-time insights into the consumption patterns or usage metrics of customers of the user. In some embodiments, invoices generated by invoicing module 340 or rating or usage reports generated by reporting module 350 may be viewed, edited, shared, exported, or downloaded via usage dashboard 360.

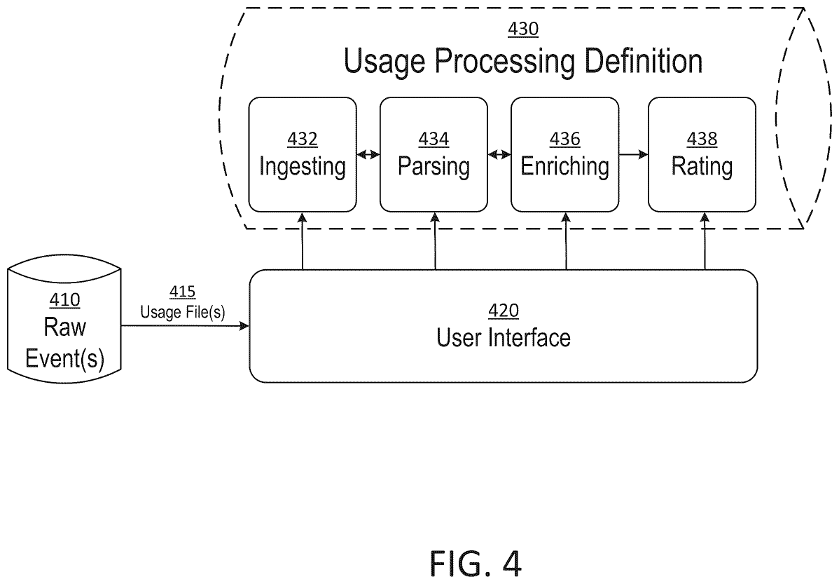

FIG. 4 illustrates example usage processing definition 430 for a billing system of example environment 100 of FIG. 1, according to some embodiments. Environment 100 may include a software marketplace. Usage processing definition 430 may include ingesting module 432, parsing module 434, enriching module 436, or rating module 438.

Ingesting module 432 may receive, collect, or import, via user interface 420, usage file(s) 415 storing usage data. The usage data may be associated with usage of a software application provided by a user (e.g., an ISV, a channel partner of an ISV). In some embodiments, the application may be provided via a system of the user. In some embodiments, the application may be provided via a software marketplace including the billing system. The usage data may include a first number of raw event(s) 410. Raw event(s) 410 may include a first plurality of values stored in a first plurality of user fields. In some embodiments, usage file(s) 415 may be one of JavaScript Object Notation (JSON) files, comma-separated values (CSV) files, or text files. In some embodiments, ingesting module 432 may receive, from the user, via user interface 420, a definition of at least one additional user field that is not represented in usage file(s) 415.

Ingesting module 432 may receive a definition of a unique identifier including one or more of the user fields. In some embodiments, at least one of usage files 415 and the definition of the unique identifier may be received from the user through user interface 420. In some embodiments, at least one of usage files 415 and the definition of the unique identifier may be received from the user through an application programming interface (API). In some embodiments, the unique identifier may include one or more of a recurring usage identifier (e.g., a subscription identifier), a metered usage identifier, a user account identifier, a customer account identifier, a software application identifier, or a software version identifier.

Parsing module 434 may apply, to raw event(s) 410, one or more validation rules to ensure raw event data is clean, accurate, or ready to be processed. Parsing module 434 may perform format validation by ensuring incoming raw event data is in an expected format (e.g., JSON, CSV, XML) and meets schema requirements (e.g., required fields, correct data types). Parsing module 434 may perform field validation to ensure all necessary fields of the first plurality of user fields are present. A subset of raw event(s) 410 including invalid, missing, or undefined user fields, or a subset of raw event(s) 410 that otherwise fail to satisfy a validation rule (e.g., a raw event that lacks a unique identifier), may trigger alerts for manual review or may be rejected or discarded. Parsing module 434 may perform data consistency checks to validate that raw event data matches existing records where applicable (e.g., checking whether a customer ID exists before processing a subscription update). Parsing module 434 may perform duplication checks to ensure that duplicate raw event data is not ingested.

Usage data may be aggregated by combining matching raw events using the unique identifier, resulting in aggregated usage data. The aggregated usage data may include a second number of aggregated events. Each aggregated event may include a second plurality of values stored in a second plurality of user fields. The second number of aggregated events may be less than the first number of raw events, and the second plurality of user fields may be a first subset of the first plurality of user fields.

Ingesting module 432 may receive, from the user, via user interface 420, a mapping between the second plurality of user fields and a plurality of predefined fields. In some embodiments, the mapping may be received from the user through an API. In some embodiments, ingesting module 432 may receive, from the user, via user interface 420, a definition of a data transformation operation. In some embodiments, the definition of the data transformation operation may be received from the user through an API. The data transformation operation may include receiving, as input, data from at least one field in the second plurality of user fields, and generating, as output, data to be stored in at least one field in the plurality of predefined fields. The data transformation operation may be performed on the aggregated usage data. In some embodiments, the data transformation operation may include one or more of a scripting operation, a logic operation, or a conditional operation.

The mapping may be applied to aggregated usage data to store the aggregated usage data in a usage database, resulting in stored usage data. The stored usage data may include a third number of usage events. Each usage event may include a third plurality of values stored in the plurality of predefined fields.

Enriching module 436 may further transform or enrich usage data to make the usage data more suitable for further processing. For one example, enriching module 436 may convert currency values into a common format or convert a payment method status code (e.g., “A” for active) into a human-readable string. For another example, enriching module 436 may normalize usage data to a consistent unit of measurement (e.g., converting gigabytes to megabytes, or minutes to hours) predefined by the billing system. For a further example, enriching module 436 may convert transaction amounts into the default currency of the billing system using up-to-date exchange rates. For yet another example, enriching module 436 may enrich the usage data with additional context (e.g., customer information, such as account type, contract terms, or demographics) from internal systems or third-party sources.

Rating module 438 may receive, from the user, via user interface 420, a definition of a usage rate card. The definition of the usage rate card may include a usage rate, rating rule, or rating logic for at least one field in the second plurality of user fields and a usage rate modifier. Rating module 438 may apply a usage rate, rating rule, or rating logic to the stored usage data to determine a total usage charge. An invoice may be generated based on the total usage charge. The total usage charge may be further determined by applying the usage rate modifier to an aggregated event that matches the usage rate, rating rule, or rating logic. In some embodiments, the rating rule may include an exchange rate or a prorated rate, which may be defined by a user or determined by the billing system. Rating module 438 may use the exchange rate or the prorated rate to evaluate at least one value of the at least one field in the second plurality of user fields.

Rating module 438 may receive rating logic from a user, via user interface 420, or the rating logic may be predetermined by the billing system. Rating module 438 may apply, to usage data, the rating logic to determine a total charge for a given period (e.g., monthly, quarterly). Rating module 438 may apply rating logic for various pricing models. Example pricing models may include the following or a combination thereof: fixed pricing, wherein a flat rate is charged based on a subscription plan or a bundle of features; usage-based pricing, wherein charges depend on actual use of software or services, such as the number of API calls, data storage, or bandwidth usage; tiered or sliding scale pricing, wherein charges depend on usage thresholds or customer tiers (e.g., the first 100 units at $0.10/unit, the next 500 units at $0.08/unit); volume-based pricing, wherein discounts are applied based on the volume of usage or purchases (e.g., higher usage triggers a discount on per-unit rate); conditional pricing, wherein charges may be modified depending on certain conditions (e.g., a special discount might apply if a customer exceeds a particular usage threshold, or a service fee might apply if a customer uses a premium feature); or custom pricing, wherein charges include special pricing for individual customers (e.g., negotiated discounts, loyalty rewards, or custom bundles).

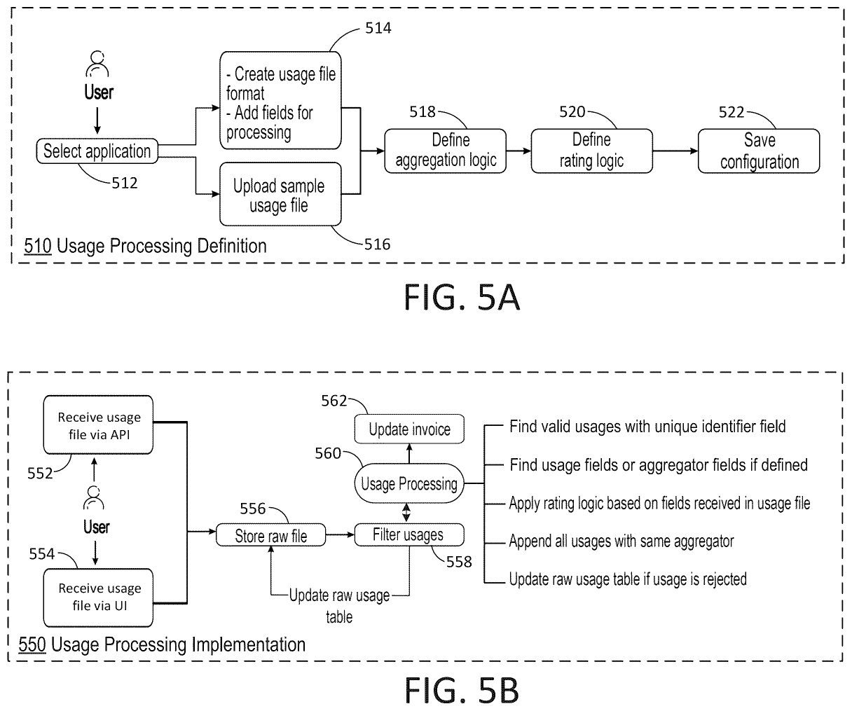

FIGS. 5A-5B illustrate example process 510 for usage processing definition and example process 550 for usage processing implementation, according to some embodiments. In some embodiments, processes as disclosed herein may include one or more steps in processes 510 or 550 performed by a processor circuit executing instructions stored in a memory circuit, in a client device, in a remote server, or in a database, communicatively coupled through a network (e.g., processors 212, memories 220, client device(s) 110, server(s) 130, database 152, and network 150). In some embodiments, one or more of the steps in processes 510 and 550 may be performed by an ingesting module, an aggregating module, a rating module, or an invoicing module (e.g., ingesting module 232, aggregating module 234, rating module 236, or invoicing module 238). In some embodiments, processes consistent with the present disclosure may include at least one or more steps or operations as in process 510 or process 550 performed in a different order, simultaneously, quasi-simultaneously, or overlapping in time.

Process 510 for usage processing definition may enable a user of a billing system of a software marketplace (e.g., an ISV, a channel partner of an ISV) to customize usage definitions in order to map a format of the user to a format of the billing system. At step 512, a user may select an application offered by the user. At step 514, the user may create a usage file format and select or add fields for processing. At step 516, a user may upload a sample usage file including sample usage data. At step 518, a user may define aggregation logic, which may be used to map the user-defined fields to the billing system-defined fields. At step 520, the user may define rating logic, which may be applied to usage data to determine chargers for usage of the application by a customer. At step 522, the configuration may be saved or activated.

Process 550 for usage processing implementation may enable the user to provide at least one usage file for at least one application to the billing system according to the custom format of the user, which the billing system may, according to the configuration, map to the predefined format of the billing system. At step 552, the billing system may receive the usage file from a user via API. At step 554, the billing system may receive the usage file from a user via a user interface (UI) of the billing system. At step 556, the billing system may store the “raw” file (i.e., the user-customized usage file). At step 558, the billing system may filter usage data from the raw file according to one or more validation rules. At step 560, the billing system may conduct usage processing. Usage processing may include finding or identifying, from the usage file, valid usages with unique identifier fields according to the saved configuration. Usage processing may include finding or identifying, from the usage file, (i) user-defined usage fields (e.g., user ID, customer ID, application ID, raw event ID, raw event data, usage quantity, usage unit price, currency type) for mapping to billing system-defined usage fields, or (ii) user-defined aggregator fields for aggregating usage data by combining matching raw events using unique identifiers. Usage processing may include applying a mapping of the user-defined fields to the billing-system defined fields. Usage processing may include applying rating logic based on user-defined fields received in the usage file. Usage processing may include appending usages with the same aggregator. In some embodiments, appending usages with the same aggregator may include appending usages with the same aggregator as a single line item (e.g., a single line item in a billing system form or in an invoice). Usage processing may include updating the raw usage table if usage data is rejected (e.g., if usage data is rejected according to a validation rule). At step 562, the billing system may generate or update an invoice based on the processed usage data, which may include usage data to which rating logic has been applied.

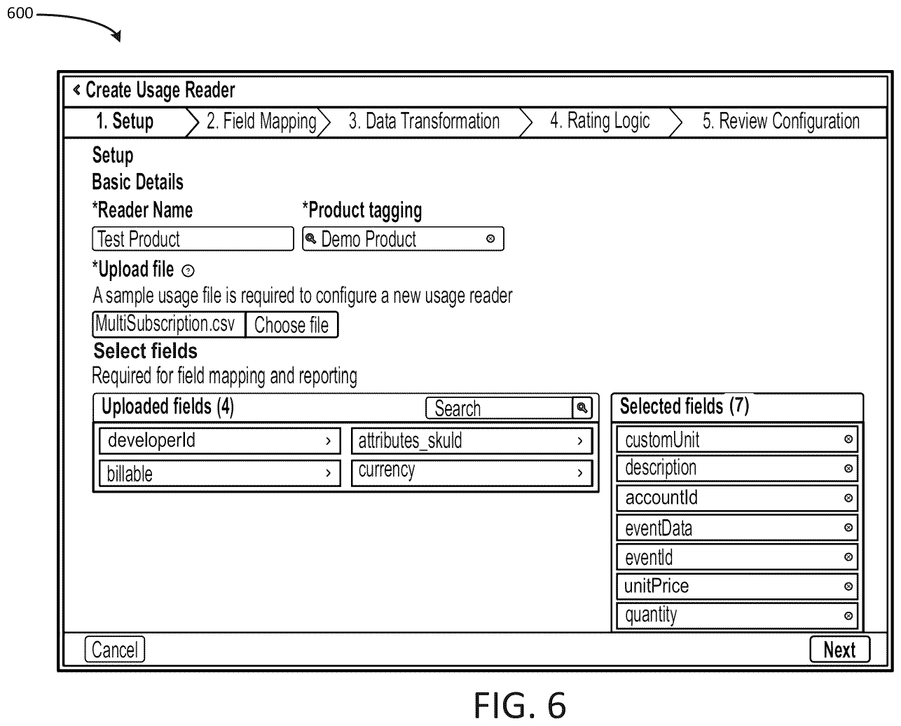

FIG. 6 illustrates an example user interface 600 for field selection during usage processing definition for a billing system, according to some embodiments. As shown in example user interface 600, a user may create a usage reader (that is, a usage processing configuration) for a usage file by providing basic details, such as a reader name (e.g., “Test Product”) and a product tagging (e.g., “Demo Product”), providing a sample usage file, and selecting user-defined fields. The product tagging may correspond to an application of the user. In some embodiments, the application may be provided via a system of the user. In some embodiments, the application may be provided via a software marketplace including the billing system. A user may upload a sample usage file including sample usage data for the application (e.g., “MultiSubscription.csv”). After the user has uploaded the sample usage file, the billing system may extract user-defined fields from the sample usage file. For example, the sample usage file may contain headers, which the billing system may identify and extract as user-defined fields. In some embodiments, a user may search the sample usage file for user-defined fields and add located user-defined fields to the list of uploaded fields. Once the user-defined fields have been uploaded, a user may select user-defined fields for field mapping or reporting. For example, as shown in FIG. 6, the seven (7) selected fields include the following: “customUnit,” “description,” “accountId,” “eventData,” “eventId,” “unitPrice,” and “quantity.” As shown in FIG. 6, the four (4) unselected user-defined fields include the following: “developerId,” “billable,” “attributes_skuld,” and “currency.”

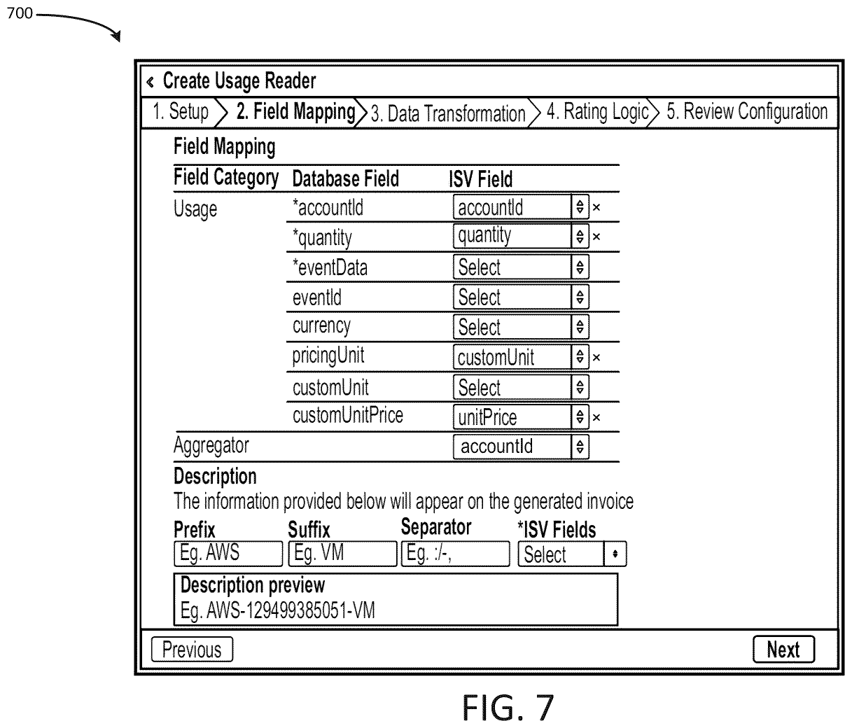

FIG. 7 illustrates an example user interface 700 for field mapping during usage processing definition for a billing system, according to some embodiments. As shown in example user interface 700, a user may create a usage reader (that is, a usage processing configuration) for a usage file by defining a field mapping. A field category may include “Usage” and “Aggregator.” Corresponding to the “Usage” field category is a first column listing predefined system fields (“Database Field”). Next to the first column is a second column listing drop-down menus including previously selected user-defined fields (“ISV Field”) (e.g., FIG. 6, “Selected fields”). From each drop-down menu, a user may select a user-defined field to map to a predefined system field. For example, as shown in FIG. 7, user-defined field “accountId” has been selected to map to predefined system field “accountId”; user-defined field “quantity” has been selected to map to predefined system field “quantity”; user-defined field “customUnit” has been selected to map to predefined system field “pricingUnit”; and user-defined field “unitPrice” has been selected to map to predefined system field “customUnitPrice.” In some embodiments, the drop-down menus may display suggested selections determined by the billing system, which may be changed by the user. Corresponding to the “Aggregator” field category is a drop-down menu including previously selected user-defined fields (“ISV Field”). From the drop-down menu, a user may select one or more user-defined fields to be an aggregator. For example, as shown in FIG. 7, user-defined field “accountId” has been selected as the aggregator.

As an example, a usage file may include ten thousand (10,000) records for ten (10) subscriptions, and the usage file may include identifiers for subscription, product, and edition. A user may decide to aggregate usage data based on any of the following: only subscription, product, or edition; a combination of only two of subscription, product, and edition; or all three of subscription, product, and edition. The user may define, via aggregation logic, how many usage lines for each identifier should be shown. More aggregation fields may mean fewer usage lines in billing or downstream systems.

A user may also define fields that will appear on a generated invoice. For example, as shown in FIG. 7, the description fields may include “Prefix,” “Suffix,” “Separator,” and user-defined fields (“ISV Fields”).

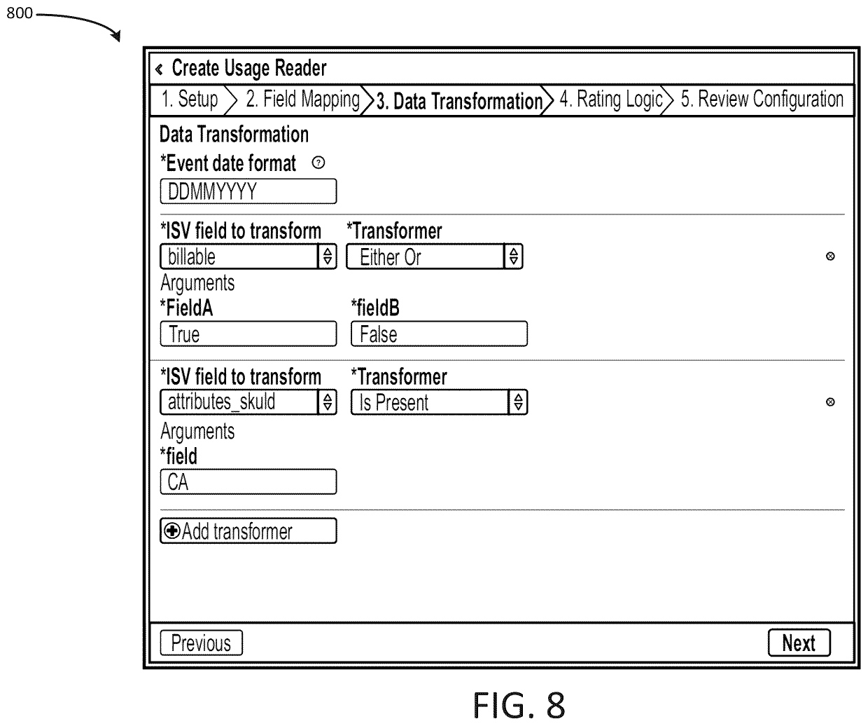

FIG. 8 illustrates an example user interface 800 for enrichment during usage processing definition for a billing system, according to some embodiments. As shown in example user interface 800, a user may create a usage reader (that is, a usage processing configuration) for a usage file by defining data enrichments or transformations. A user may select, from user-defined fields (e.g., FIG. 6, “Uploaded fields”), which user-defined fields are to be enriched during usage processing implementation, and a user may define transformers or parsing logic to be applied to specified user-defined fields during usage processing implementation. In some embodiments, transformers or parsing logic may take data from at least one field as an input and perform an operation on the input to generate output data to be stored in another field.

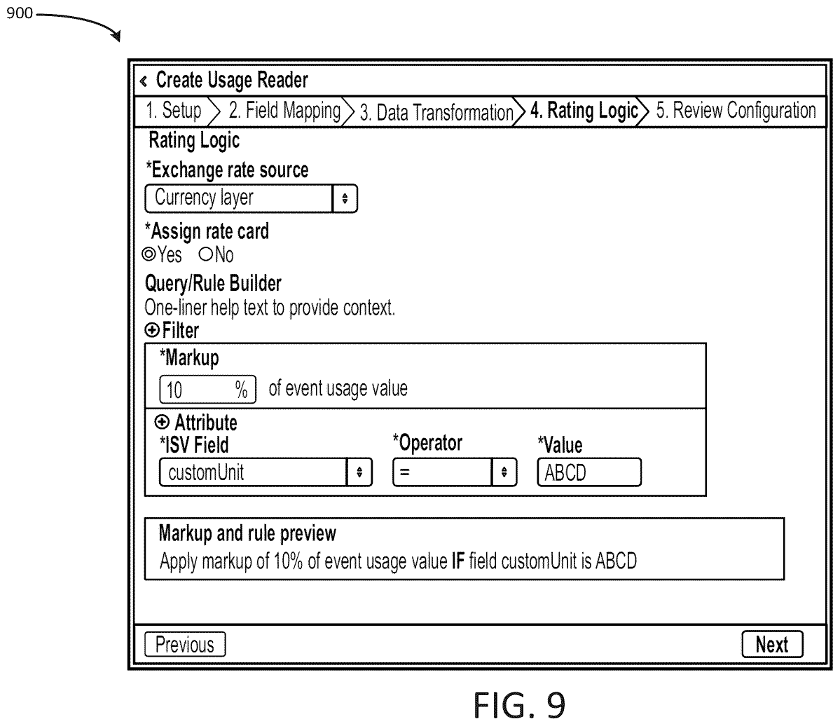

FIG. 9 illustrates an example user interface 900 for rating during usage processing definition for a billing system, according to some embodiments. As shown in example user interface 900, a user may create a usage reader (that is, a usage processing configuration) for a usage file by defining rating logic. A user may define rating logic by selecting an exchange rate source (e.g., “Currency layer”) or by assigning a rate card. The rate card may be defined using a query or rule builder (“Query/Rule Builder”). Rating logic may enable a user to mark up or mark down a value. For example, as shown in FIG. 9, a user may provide a markup percentage (e.g., ten (10) percent) of an event usage value, and the user may select a user-defined field (e.g., “customUnit”), an operator (e.g., equality operator), and a value (e.g., “ABCD”) for a rule. Based on the markup and the rule, the rate card may include the following logic: “Apply markup of 10% of event usage value IF field customUnit is ABCD.” For another example, a user may provide a markdown percentage (e.g., twenty (20) percent) of an event usage value, and the user may select a user-defined field (e.g., “zipCode”), an operator (e.g., equality operator), and a value (e.g., “1234”) for a rule. Based on the markdown and the rule, the rate card may include the following logic: “IF zipCode=1234, then provide 20% markdown.”

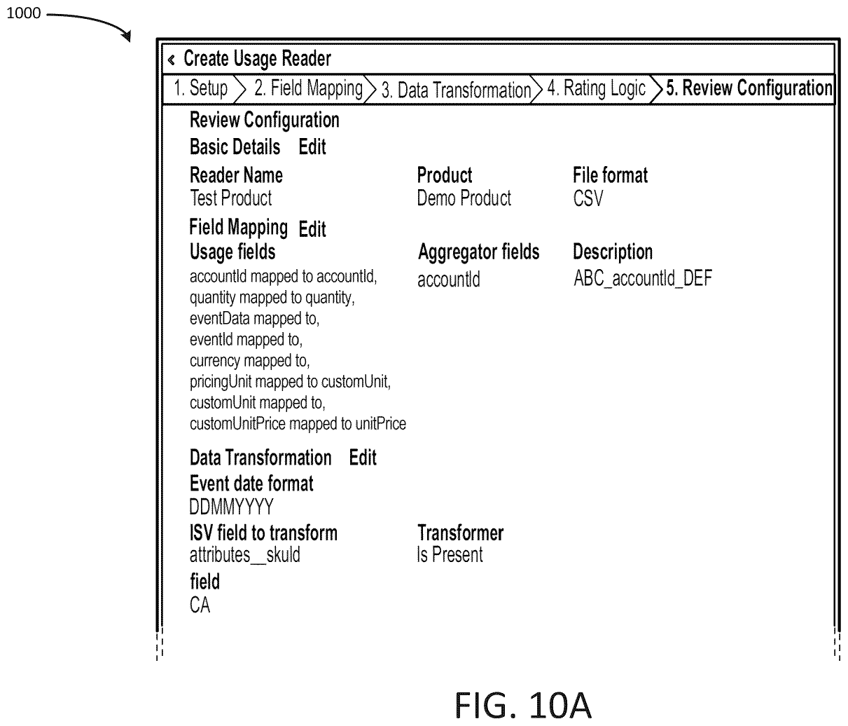

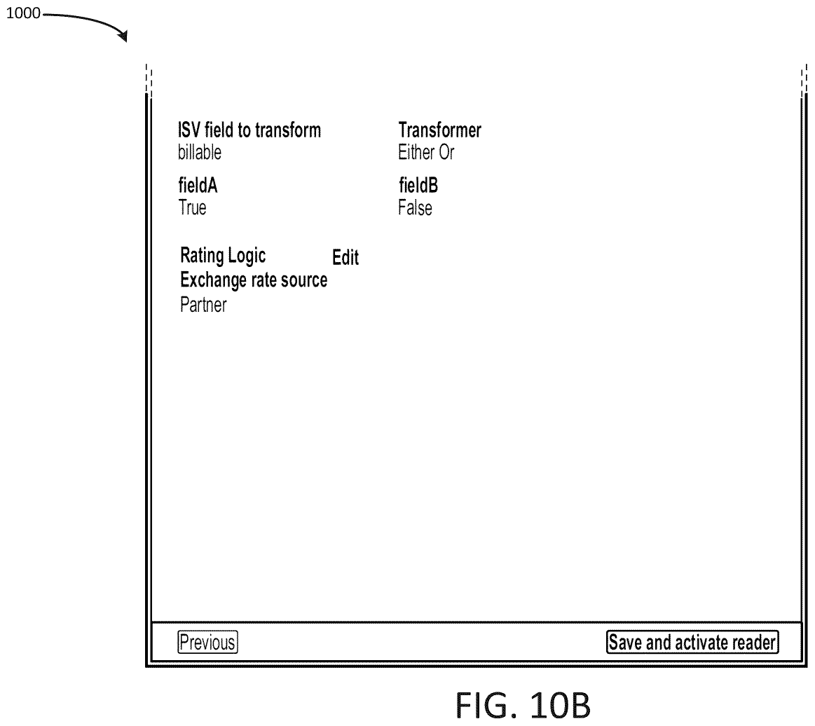

FIGS. 10A-10B illustrate an example user interface 1000 for review of the configuration during usage processing definition for a billing system, according to some embodiments. As shown in example user interface 1000, a user may create a usage reader (that is, a usage processing configuration) for a usage file by saving or activating the usage reader. Once a user has reviewed the usage reader definition, the user may activate the reader (e.g., by clicking the “Save and activate reader” button) so that usage files may be received by the billing system in the custom format of the user and so that the billing system may process the usage files according to the configuration. In some embodiments, usage files may be received by JSON format, API, or direct file upload.

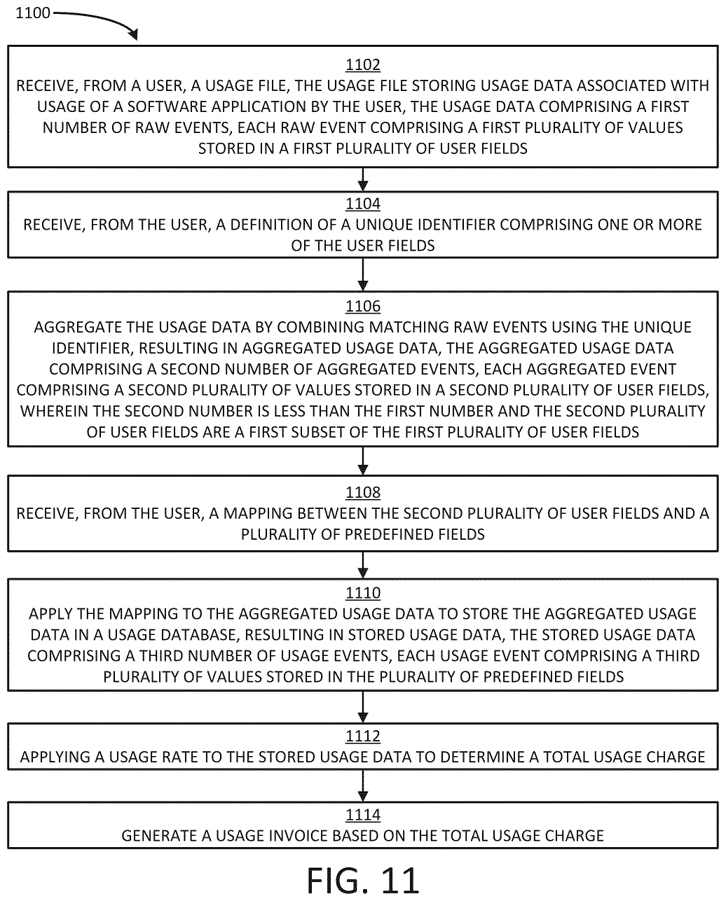

FIG. 11 is a flowchart illustrating operations in a method 1100 for billing for usage of software applications, according to some embodiments. In some embodiments, methods as disclosed herein may include one or more steps in method 1100 performed by a processor circuit executing instructions stored in a memory circuit, in a client device, in a remote server, or in a database, communicatively coupled through a network (e.g., processors 212, memories 220, client device(s) 110, server(s) 130, database 152, and network 150). In some embodiments, one or more of the steps in method 1100 may be performed by an ingesting module, an aggregating module, a rating module, or an invoicing module (e.g., ingesting module 232, aggregating module 234, rating module 236, or invoicing module 238). In some embodiments, processes consistent with the present disclosure may include at least one or more steps or operations as in method 1100 performed in a different order, simultaneously, quasi-simultaneously, or overlapping in time.

Operation 1102 may include receiving, from a user, a usage file, the usage file storing usage data associated with usage of a software application by the user, the usage data including a first number of raw events, each raw event including a first plurality of values stored in a first plurality of user fields. In some embodiments, the user may include an independent software vendor (ISV). In some embodiments, the usage file may be one of a JavaScript Object Notation (JSON) file, a comma-separated values (CSV) file, or a text file. In some further aspects of the embodiments, operation 1102 may include applying, to each raw event, a validation rule. In some further aspects of the embodiments, operation 1102 may include discarding a second subset of the raw events that do not pass the validation rule. In some further aspects of the embodiments, operation 1102 may include receiving, from the user, a definition of at least one additional user field that is not represented in the usage file.

Operation 1104 may include receiving, from the user, a definition of a unique identifier including one or more of the user fields. In some embodiments, at least one of the usage file and the definition of the unique identifier may be received from the user through an application programming interface (API). In some embodiments, at least one of the usage file and the definition of the unique identifier may be received from the user through a graphical user interface. In some embodiments, the unique identifier may include one or more of a recurring usage identifier (e.g., a subscription identifier), a metered usage identifier, a user account identifier, a customer account identifier, a software application identifier, or a software version identifier.

Operation 1106 may include aggregating the usage data by combining matching raw events using the unique identifier, resulting in aggregated usage data, the aggregated usage data including a second number of aggregated events, each aggregated event including a second plurality of values stored in a second plurality of user fields, wherein the second number may be less than the first number, and the second plurality of user fields may be a first subset of the first plurality of user fields.

Operation 1108 may include receiving, from the user, a mapping between the second plurality of user fields and a plurality of predefined fields. In further aspects of the embodiments, operation 1108 may include receiving, from the user, a definition of a data transformation operation. The data transformation operation may include receiving, as input, data from at least one field in the second plurality of user fields, and generating, as output, data to be stored in at least one field in the plurality of predefined fields. In further aspects of the embodiments, operation 1108 may include performing the data transformation operation on the aggregated usage data. In some further aspects of the embodiments, the data transformation operation may include one or more of a scripting operation, a logic operation, and a conditional operation.

Operation 1110 may include applying the mapping to the aggregated usage data to store the aggregated usage data in a usage database, resulting in stored usage data, the stored usage data including a third number of usage events, each usage event including a third plurality of values stored in the plurality of predefined fields.

Operation 1112 may include applying a usage rate to the stored usage data to determine a total usage charge. In some embodiments, applying the usage rate to the stored usage data may include receiving, from the user, a definition of a usage rate card, the definition including a rating rule for at least one field in the second plurality of user fields and a usage rate modifier, wherein the total usage charge is further determined by applying the usage rate modifier to an aggregated event that matches the rating rule. In some aspects of the embodiments, the rating rule may include an exchange rate or a prorated rate, which may be predetermined or may be defined by the user, and which may be used to evaluate at least one value of the at least one field in the second plurality of user fields. Operation 1114 may include generating a usage invoice based on the total usage charge.

### Hardware Overview

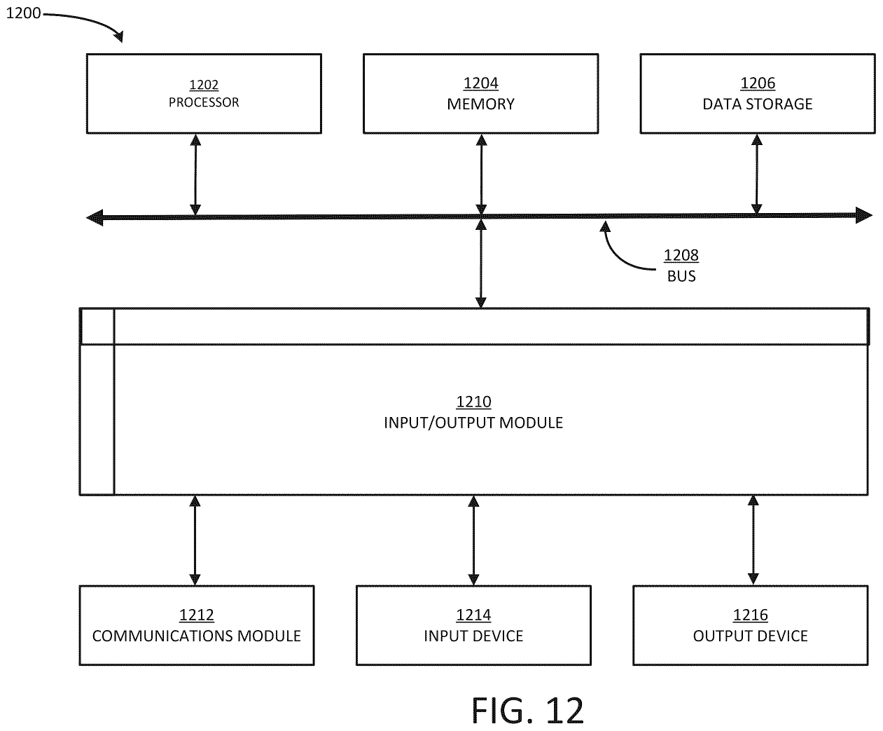

FIG. 12 is a block diagram illustrating an exemplary computer system 1200 with which client devices, and the methods or processes described in FIGS. 3-5 and 11, may be implemented, according to some embodiments. In certain aspects, the computer system 1200 may be implemented using hardware or a combination of software and hardware, either in a dedicated server, or integrated into another entity, or distributed across multiple entities.

Computer system 1200 (e.g., client device(s) 110 and server(s) 130) may include bus 1208 or other communication mechanisms for communicating information, and a processor 1202 (e.g., processors 212) coupled with bus 1208 for processing information. By way of example, computer system 1200 may be implemented with one or more processors 1202. Processor 1202 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 1200 may include, in addition to hardware, code that creates an execution environment for the computer program in question, e.g., code that constitutes processor firmware, a protocol stack, a database management system, an operating system, or a combination of one or more of them stored in an included memory 1204 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1208 for storing information and instructions to be executed by processor 1202. Processor 1202 and the memory 1204 may be supplemented by, or incorporated in, special purpose logic circuitry.

The instructions may be stored in memory 1204 and implemented in one or more computer program products, e.g., one or more modules of computer program instructions encoded on a computer-readable medium for execution by, or to control the operation of, computer system 1200, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1204 may also be used for storing temporary variable or other intermediate information during execution of instructions to be executed by processor 1202.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 1200 further includes a data storage device 1206 such as a magnetic disk or optical disk, coupled to bus 1208 for storing information and instructions. Computer system 1200 may be coupled via input/output module 1210 to various devices. Input/output module 1210 may be any input/output module. Exemplary input/output modules 1210 include data ports such as Universal Serial Bus (USB) ports. The input/output module 1210 may be configured to connect to a communications module 1212. Exemplary communications modules 1212 (e.g., communications modules 218) include networking interface cards, such as Ethernet cards and modems. In certain aspects, input/output module 1210 may be configured to connect to a plurality of devices, such as an input device 1214 (e.g., input device 214) and/or an output device 1216 (e.g., output device 216). Exemplary input devices 1214 include a keyboard and a pointing device, e.g., a mouse or a trackball, by which a user may provide input to computer system 1200. Other kinds of input devices 1214 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 1216 include display devices, such as an LCD (liquid crystal display) monitor, for displaying information to the user.

According to one aspect of the present disclosure, client device(s) 110 and server(s) 130 may be implemented using computer system 1200 in response to processor 1202 executing one or more sequences of one or more instructions contained in memory 1204. Such instructions may be read into memory 1204 from another machine-readable medium, such as data storage device 1206. Execution of the sequences of instructions contained in memory 1204 causes processor 1202 to perform the process steps described herein. One or more processors in a multi-processing arrangement may also be employed to execute the sequences of instructions contained in memory 1204. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 1200 may include clients and servers. A client and server may be generally remote from each other and typically interact through a communication network. The relationship of client and server arises by virtue of computer programs running on the respective computers and having a client-server relationship to each other. Computer system 1200 may be, for example, and without limitation, a desktop computer, laptop computer, or tablet computer. Computer system 1200 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1202 for execution. Such a medium may take many forms, including, but not limited to, non-volatile media, volatile media, and transmission media. Non-volatile media include, for example, optical or magnetic disks, such as data storage device 1206. Volatile media include dynamic memory, such as memory 1204. Transmission media include coaxial cables, copper wire, and fiber optics, including the wires forming bus 1208. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method for billing for usage of software applications, comprising:
receiving, from a user, a usage file, the usage file storing usage data associated with usage of a software application, the usage data comprising a first number of raw events, each raw event comprising a first plurality of values stored in a first plurality of user fields;
receiving, from the user, a definition of a unique identifier comprising one or more of the user fields;
aggregating the usage data by combining matching raw events using the unique identifier, resulting in aggregated usage data, the aggregated usage data comprising a second number of aggregated events, each aggregated event comprising a second plurality of values stored in a second plurality of user fields, wherein the second number is less than the first number and the second plurality of user fields are a first subset of the first plurality of user fields;
receiving, from the user, a mapping between the second plurality of user fields and a plurality of predefined fields;
applying the mapping to the aggregated usage data to store the aggregated usage data in a usage database, resulting in stored usage data, the stored usage data comprising a third number of usage events, each usage event comprising a third plurality of values stored in the plurality of predefined fields;
applying a usage rate to the stored usage data to determine a total usage charge; and
generating a usage invoice based on the total usage charge.

2. The method of claim 1, further comprising:
receiving, from the user, a definition of a data transformation operation, the data transformation operation including receiving, as input, data from at least one field in the second plurality of user fields, and generating, as output, data to be stored in at least one field in the plurality of predefined fields; and
performing the data transformation operation on the aggregated usage data.

3. The method of claim 2, wherein the data transformation operation comprises one or more of a scripting operation, a logic operation, and a conditional operation.

4. The method of claim 1, wherein applying the usage rate to the stored usage data comprises:
receiving, from the user, a definition of a usage rate card, the definition comprising a rating rule for at least one field in the second plurality of user fields and a usage rate modifier, wherein the total usage charge is further determined by applying the usage rate modifier to an aggregated event that matches the rating rule.

5. The method of claim 4, wherein the rating rule comprises an exchange rate or a prorated rate used to evaluate at least one value of the at least one field.

6. The method of claim 1, wherein at least one of the usage file and the definition of the unique identifier is received from the user through an application programming interface.

7. The method of claim 1, wherein at least one of the usage file and the definition of the unique identifier is received from the user through a graphical user interface.

8. The method of claim 1, further comprising:
applying, to each raw event, a validation rule; and
discarding a second subset of the raw events that do not pass the validation rule.

9. The method of claim 1, further comprising receiving, from the user, a definition of at least one additional user field that is not represented in the usage file.

10. The method of claim 1, wherein the unique identifier comprises one or more of a subscription identifier, a customer account identifier, a software application identifier, or a software version identifier.

11. The method of claim 1, wherein the usage file is one of a JavaScript Object Notation (JSON) file, a comma-separated values (CSV) file, or a text file.

12. The method of claim 1, wherein the user is an independent software vendor (ISV).

13. A non-transitory computer-readable medium storing a program for billing for usage of software applications, which when executed by a computer, configures the computer to:
receive, from a user, a usage file storing usage data associated with usage of a software application, the usage data comprising a first number of raw events, each raw event comprising a first plurality of values stored in a first plurality of user fields;
receive, from the user, a definition of a unique identifier comprising one or more of the user fields;
aggregate the usage data by combining matching raw events using the unique identifier, resulting in aggregated usage data, the aggregated usage data comprising a second number of aggregated events, each aggregated event comprising a second plurality of values stored in a second plurality of user fields, wherein the second number is less than the first number and the second plurality of user fields are a first subset of the first plurality of user fields;
receive, from the user, a mapping between the second plurality of user fields and a plurality of predefined fields;
apply the mapping to the aggregated usage data to store the aggregated usage data in a usage database, resulting in stored usage data, the stored usage data comprising a third number of usage events, each usage event comprising a third plurality of values stored in the plurality of predefined fields;
apply a usage rate to the stored usage data to determine a total usage charge; and
generate a usage invoice based on the total usage charge.

14. The non-transitory computer-readable medium of claim 13, wherein the program, when executed by the computer, further configures the computer to:
receive, from the user, a definition of a data transformation operation, the data transformation operation including receiving, as input, data from at least one field in the second plurality of user fields, and generating, as output, data to be stored in at least one field in the plurality of predefined fields; and
perform the data transformation operation on the aggregated usage data.

15. The non-transitory computer-readable medium of claim 13, wherein the program, when executed by the computer, configures the computer to apply the usage rate to the stored usage data by configuring the computer to:
receive, from the user, a definition of a usage rate card, the definition comprising a rating rule for at least one field in the second plurality of user fields and a usage rate modifier, wherein the total usage charge is further determined by applying the usage rate modifier to an aggregated event that matches the rating rule.

16. The non-transitory computer-readable medium of claim 13, wherein the program, when executed by the computer, further configures the computer to:
apply, to each raw event, a validation rule; and
discard a second subset of the raw events that do not pass the validation rule.

17. The non-transitory computer-readable medium of claim 13, wherein the unique identifier comprises one or more of a subscription identifier, a customer account identifier, a software application identifier, or a software version identifier.

18. A system for billing for usage of software applications, comprising:
a processor; and
a non-transitory computer-readable medium storing a set of instructions, which when executed by the processor, configure the system to:
receive, from a user, a usage file storing usage data associated with usage of a software application, the usage data comprising a first number of raw events, each raw event comprising a first plurality of values stored in a first plurality of user fields;
receive, from the user, a definition of a unique identifier comprising one or more of the user fields;
aggregate the usage data by combining matching raw events using the unique identifier, resulting in aggregated usage data, the aggregated usage data comprising a second number of aggregated events, each aggregated event comprising a second plurality of values stored in a second plurality of user fields, wherein the second number is less than the first number and the second plurality of user fields are a subset of the first plurality of user fields;
receive, from the user, a mapping between the second plurality of user fields and a plurality of predefined fields;
apply the mapping to the aggregated usage data to store the aggregated usage data in a usage database, resulting in stored usage data, the stored usage data comprising a third number of usage events, each usage event comprising a third plurality of values stored in the plurality of predefined fields;
apply a usage rate to the stored usage data to determine a total usage charge; and
generate a usage invoice based on the total usage charge, wherein the unique identifier comprises one or more of a subscription identifier, a customer account identifier, a software application identifier, or a software version identifier.

19. The system of claim 18, wherein the instructions, when executed by the processor, further configure the system to:
receive, from the user, a definition of a data transformation operation, the data transformation operation including receiving, as input, data from at least one field in the second plurality of user fields, and generating, as output, data to be stored in at least one field in the plurality of predefined fields; and
perform the data transformation operation on the aggregated usage data.

20. The system of claim 18, wherein the instructions, when executed by the processor, configure the system to apply the usage rate to the stored usage data by configuring the system to:
receive, from the user, a definition of a usage rate card, the definition comprising a rating rule for at least one field in the second plurality of user fields and a usage rate modifier, wherein the total usage charge is further determined by applying the usage rate modifier to an aggregated event that matches the rating rule.
